(19) United States
(12) Patent Application Publication
(10) Pub. No.: US 2013/0215554 A1
(43) Pub. Date: Aug. 22, 2013

(54) ELECTRIC DOUBLE LAYER CAPACITOR PACKAGE AND METHOD FOR MANUFACTURING THE SAME

(71) Applicants: Ho Won SON, Cheonan-si (KR); Jung Won LEE, Cheonan-si (KR); Ki Yeon LEE, Asan-si (KR)

(72) Inventors: Ho Won SON, Cheonan-si (KR); Jung Won LEE, Cheonan-si (KR); Ki Yeon LEE, Asan-si (KR)

(73) Assignee: ROSWIN, INC., Cheonan-si (KR)

(21) Appl. No.: 13/598,728

(22) Filed: Aug. 30, 2012

(30) Foreign Application Priority Data
Feb. 16, 2012 (KR) 10-2012-0015778

(51) Int. Cl. H01G 7/00; H01G 9/10; H01G 9/155

(52) U.S. Cl. 361/502; 29/25.42

(57) ABSTRACT

An electric double layer capacitor and a method for manufacturing the same, in which one or more projections are formed on an inner bottom surface of a lower case, which is a concave container made of ceramic, in a the process of sequentially stacking a lower electrode, a separator, and an upper electrode in the lower case and covering the lower case with a sealing plate. It is possible to eliminate the process of injecting a bonding liquid and strongly connect the lower electrode and the upper electrode to the lower case and the sealing plate, respectively, by means of the projections, thus preventing the occurrence of a short circuit and reducing the equivalent series resistance.

### CROSS-REFERENCE TO RELATED PATENT APPLICATION

This application claims the benefit of Korean Patent Application No. 102012-0015778, filed on Feb. 16, 2012, in the Korean Intellectual Property Office, the disclosure of which is incorporated herein in its entirety by reference.

### BACKGROUND OF THE INVENTION

1. Field of the Invention

The present invention relates to an electric double layer capacitor package and a method for manufacturing the same and, more particularly, to an electric double layer capacitor package and a method for manufacturing the same, in which one or more projections are formed on an inner bottom surface of a lower case, which is a concave container made of ceramic, in a the process of sequentially stacking a lower electrode, a separator, and an upper electrode in the lower case and covering the lower case with a sealing plate.

2. Description of the Related Art

In various electronic products such as information communications devices and the like, stable energy supply is a very important factor, and such a function is typically performed by a capacitor. That is, the capacitor serves to collect electricity in circuits of the information communications devices or various electronic products and output the electricity, thus stabilizing the flow of electricity within the circuits. A typical capacitor has a very short charge and discharge time, a long lifespan, and a high output density, but has a low energy density, and thus has limitations for use as an energy storage device.

Thus, in order to overcome these limitations, new types of capacitors such as electric double layer capacitors (ECLCs) having a high output density with a short charge and discharge time have recently been developed and have attracted much attention as next-generation energy devices along with secondary batteries.

The EDLC is an energy storage device using a pair of electrodes having different polarities and has many advantages in that it can be continuously charged and discharged, has high energy efficiency and output, and has excellent durability and stability, compared to other typical capacitors. Thus, the EDLC which can charge and discharge high current is promising as a storage device with high charge and discharge frequency such as an auxiliary power source for a cellular phone, an auxiliary power source for an electric vehicle, an auxiliary power source for a solar battery, etc.

The basic structure of the EDLC includes an electrode having a relatively large surface area such as a porous electrode, an electrolyte, a current collector, and a separator, and the EDLC operates on the basis of an electrochemical mechanism generated as ions in the electrolyte flow along an electric field due to a voltage applied to both terminals of a unit cell electrode and are absorbed onto an electrode surface.

Korean Patent Publication No. 10-2006-0008102 discloses an electric double layer capacitor in which positive and negative electrodes, a separator, and an electrolyte are contained in a ceramic container, and FIG. 1 is a representative drawing of the prior art literature.

However, when the electric double layer capacitor is manufactured according to the method disclosed in the above prior art literature, the width, thickness, height, etc. of each container vary due to the nature of ceramic during the process of manufacturing the ceramic containers, which is problematic. As a result, manufacturing defects occur during the process of accommodating the electrodes, the separator, and the electrolyte in the ceramic container and then covering the ceramic container with a sealing plate.

FIGS. 2A and 2B are schematic diagrams showing the problems encountered in the prior art. FIG. 2A shows the problem encountered when the ceramic container is made smaller, and FIG. 2B shows the problem encountered when the ceramic container is made larger.

When a ceramic container 100 is made smaller as shown in FIG. 2A, the electric double layer capacitor is not completely sealed. Thus, an electrolyte leaks, ions in the electrolyte are not adsorbed onto electrodes 110, and thus electric double layer capacitor cannot function as a battery. Meanwhile, when the ceramic container 100 is made larger as shown in FIG. 2B, an upper electrode and a separator 120 of the electric double layer capacitor are not closely adhered to each other, and thus electric double layer capacitor cannot function.

Extensive research aimed at reducing the occurrence of tolerance in the ceramic containers used for the electric double layer capacitor has continued to progress, but there have been no innovative ways so far, and thus the above-described problems have not been solved.

Meanwhile, FIG. 3 is a flowchart showing a conventional process of manufacturing an electric double layer capacitor. In order to manufacture an electric double layer capacitor, after preparing various parts such as a lower case, a sealing plate, a lower electrode, an upper electrode, a separator, etc., a bonding liquid is injected onto the lower case, and the lower electrode is placed thereon such that the lower electrode is fixedly located on the lower case. Then, the bonding liquid is hardened in a drier under vacuum, an electrolyte is injected into a side space of the lower electrode, the separator is placed on the top surface of the lower electrode, the electrolyte is injected again onto the separator, the sealing plate to which the upper electrode is connected is placed on the lower case on which the lower electrode and the separator are stacked, and the lower case and the sealing plate are sealed together, thus manufacturing the electric double layer capacitor

According to the prior art, it is necessary to inject the bonding liquid at a close distance that a probe of a bonding liquid injection device is close to the bottom surface of the ceramic container but not in contact with it to effectively inject the bonding liquid during the bonding process. However, as mentioned above, it is not easy to ensure the uniform thickness of the bottom surface during the process of manufacturing the ceramic containers, and thus the bottom surfaces of the ceramic containers have different thicknesses. As a result, the probe for injecting the bonding liquid is likely to come in direct contact or collide with the ceramic container during injection of the bonding liquid. On the contrary, the bonding liquid may be injected at a far distance from the ceramic container. When the probe collides with the ceramic container, it damages the expensive bonding liquid injection device, which increases the manufacturing costs. Moreover, when the probe injects the bonding liquid at a too far distance, the bonding liquid is not separated, which is problematic.

### SUMMARY OF THE INVENTION

The present invention has been made in an effort to solve the above-described problems associated with prior art, and an object of the present invention is to provide a method for manufacturing an electric double layer capacitor, which can reduce the occurrence of manufacturing defects by overcoming manufacturing tolerances of ceramic containers each configured to accommodate the electric double layer capacitor.

Another object of the present invention is to provide a method for manufacturing an electric double layer capacitor, which can solve various problems encountered during the process of injecting a bonding liquid by eliminating the injection process, which is necessarily accompanied by a conventional process of manufacturing the electric double layer capacitor.

Still another object of the present invention is to provide a method for manufacturing an electric double layer capacitor, which can improve operational efficiency of the electric double layer capacitor by stably mounting parts of the electric double layer capacitor in fixed positions of a ceramic container.

According to an aspect of the present invention to achieve the above objects of the present invention, there is provided an electric double layer capacitor comprising: a lower case which is a concave container made of ceramic; an upper electrode and a lower electrode which are arranged opposite to each other in the lower case; a separator which is interposed between the upper electrode and the lower electrode; and a sealing plate which covers the lower case, wherein one or more projections may be formed on an inner bottom surface of the lower case.

The electric double layer capacitor may further comprise a current collector between the lower electrode and the lower case, wherein the projections may be embedded in the current collector and connected thereto.

The height of the projections may be lower than the thickness of the lower electrode.

One or more sealing plate lower surface projections may be formed on a lower surface of the sealing plate.

The electric double layer capacitor may further comprise an upper current collector between the upper electrode and the sealing plate, wherein the sealing plate lower surface projections may be embedded in the upper current collector and connected thereto.

The projections may be made of any one selected from the group consisting of nickel, zinc, copper, tungsten, aluminum, and titanium.

According to another aspect of the present invention to achieve the above objects of the present invention, there is provided a method for manufacturing an electric double layer capacitor, the method comprising the steps of: (a) forming one or more projections on an inner bottom surface of a lower case, which is a concave container made of ceramic; (b) stacking a lower electrode on the lower case, injecting an electrolyte, stacking a separator, and injecting the electrolyte again; and (c) covering the lower case with a sealing plate connected to an upper electrode.

The method may further comprise, before step (b), the step of stacking a current collector between the lower electrode and the lower case, wherein during the stacking of the current collector, the projections may be embedded in the current collector and connected thereto.

In step (a), the projections may be formed on the lower case by printing.

In step (a), the projections may be formed by stacking a plurality of sheets to form a lower surface of the lower case, piercing the uppermost sheet of the plurality of stacked sheets by a via hole, and injecting a projection-forming material into the via hole over the volume of the via hole.

Step (a) may comprise the steps of: (a-1) stacking a sheet made of carbon on a bottom surface of the lower case; (a-2) piercing the sheet by a via hole and injecting a projection-forming material into the via hole; and (a-3) applying heat to the lower case including the sheet such that the sheet is burned and removed.

The method may further comprise, before step (c), the step of forming one or more sealing plate lower surface projections on a lower surface of the sealing plate.

The method may further comprise, after step (b), the step of stacking an upper current collector on the upper electrode, wherein in step (c), the sealing plate may be covered such that the sealing plate lower surface projections, which are formed on the lower surface of the sealing plate, are embedded in the upper current collector and connected thereto.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram showing a conventional electric double layer capacitor:

FIG. 2 is a schematic diagram showing examples where defects occur due to tolerances of ceramic containers in a conventional electric double layer capacitor;

FIG. 3 is a flowchart showing a conventional process of manufacturing an electric double layer capacitor;

FIG. 4 is a plan view showing n electric double layer capacitor in accordance with an embodiment of the present invention;

FIG. 5 is a cross-sectional view showing an electric double layer capacitor in accordance with an embodiment of the present invention;

FIG. 6 is a cross-sectional view showing an electric double layer capacitor in accordance with another embodiment of the present invention:

FIG. 7 its a flowchart showing a method for manufacturing an electric double layer capacitor in accordance with an embodiment of the present invention; and

FIG. 8 is a cross-sectional view showing a lower case of an electric double layer capacitor in accordance with an embodiment of the present invention.

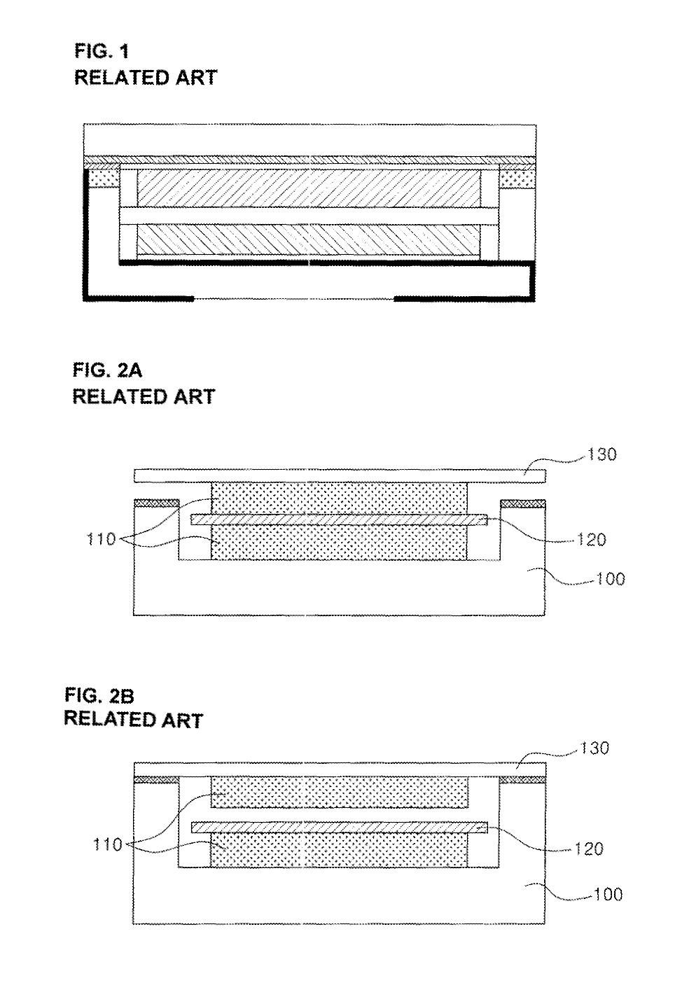

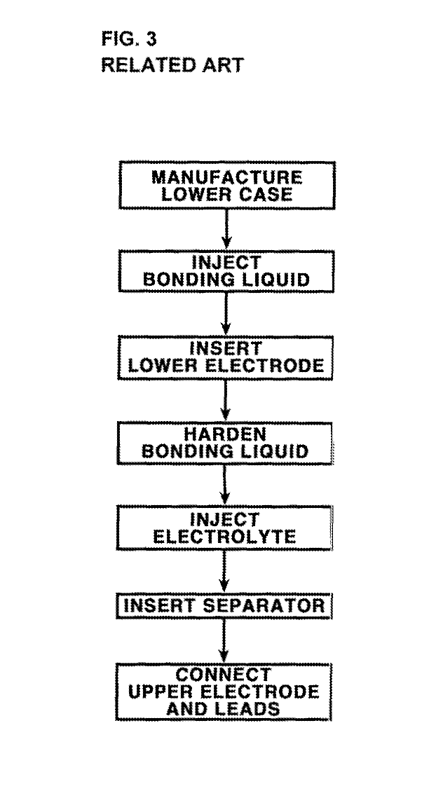

### DETAILED DESCRIPTION OF THE INVENTION

Hereinafter, the present invention will be described in detail with reference to the accompanying drawings.

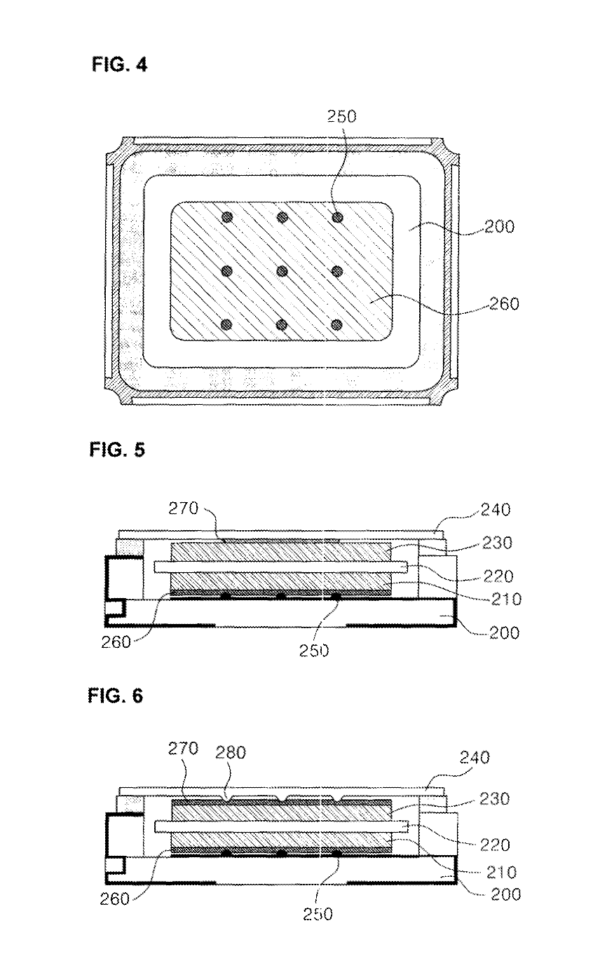

FIG. 4 is a plan view showing a lower case 200 of an electric double layer capacitor of the present invention, and FIG. 5 is a cross-sectional view showing an electric double layer capacitor in accordance with an embodiment of the present invention.

The electric double layer capacitor of the present invention comprises a lower case 200, which is a concave container made of ceramic, an upper electrode 230 and a lower electrode 210, which are arranged opposite to each other in the lower case 200, a separator 220, which is interposed between the upper electrode 230 and the lower electrode 210, and a sealing plate 240, which covers the lower case 200. Moreover, one or more projections 250 are formed on an inner bottom surface of the lower case 200. While a total of nine projections 250 are formed in a square shape in FIG. 4, this is merely an embodiment, and the number and arrangement of the projections are not limited.

Conventionally, to fix the lower electrode 210 and the like in the lower case 200, a conductive bonding liquid is applied to the inner bottom surface of the lower case 200, and the lower electrode 210 is placed thereon such that the lower electrode 210 is stacked on the lower case 200. However, according to this conventional method, the bonding liquid injection device may be damaged during the process of injecting the bonding liquid as mentioned above, and various problems occur due to manufacturing tolerances occurring in the production of the lower cases 200 using ceramic.

The present invention solves the above-described problems by forming the projections 250 on the inner bottom surface of the lower case 200. When the projections 250 are formed on the inner bottom surface of the lower case 200, the lower electrode 210 is not attached to the lower case 200 by means of the bonding liquid, but is fixedly put on the projections 250 such that the lower electrode 210 is stacked on the lower case 200. That is, some or all of the projections 250 are embedded in the lower electrode 210, and thus the lower electrode 210 and the lower case 200 are more firmly connected to each other, compared to the conventional method of simply bonding the lower electrode 210 and the lower case 200.

Conventionally, the lower electrode 210 is poorly bonded to the lower case 200 and thus moves in the lower case 200. In this case, the capacitance is reduced by the movement of the electrode and, in serious cases, the upper electrode 230 and the lower electrode 210 are in contact with each other and electrically shorted.

However, according to the present invention, the lower electrode 210 is prevented from moving in the lower case 200, and thus it is possible to maintain the capacitance and prevent the upper electrode 230 and the lower electrode 210 from being shorted. Moreover, since the lower electrode 210 and the lower case 200 are strongly coupled to each other by means of the projections 250, the contact area and the bonding strength increase to reduce the contact resistance of the electric double layer capacitor, and thus the equivalent series resistance (ESR) can be reduced.

Moreover, it is possible to solve the problem of tolerance, which occurs in the production of the ceramic containers as mentioned above, using the projections 250.

When the ceramic containers are manufactured, a tolerance of about ±10% occurs statistically. That is, even when it is intended to make the ceramic containers in the same size, the size of the ceramic containers has a tolerance up to 20%. Hence, the problems described with respect to FIG. 2 occur.

However, when the projections 250 are formed on the lower case 200 according to the present invention, the above-described problems can be solved. This is because the height of the projections 250 serves as a means as reducing the tolerances occurring in the production of the lower cases 200 using ceramic. If the height of the projections 250 is greater than the maximum tolerance of the lower case 200, the height of the inner surface of the lower case 200 is lower than the total height of the lower electrode 210, the separator 220, the upper electrode 230, and the projections 250, even when the lower case 200 is formed to have a tolerance of +10%, and thus the problem shown in FIG. 2b does not occur. Moreover, even when the lower case 200 is formed to have a tolerance of −10%, if the total height of the lower electrode 210, the separator 220, the upper electrode 230, and the projections 250, which are not embedded, is equal to the height of the inner surface of the lower case 200 by adjusting the depth of the projections 250 embedded in the lower electrode 210, the problem shown in FIG. 2a can be solved. That is, it is possible to solve the problems of manufacturing tolerances, which inevitably occur when the containers are made of ceramic, by means of the projections 250 formed on the lower case 200. However, if the height of the projections 250 is greater than the thickness of the lower electrode 210, the projection 250 may penetrate the lower electrode 210 and come in contact with the separator 220 during the connection of the lower electrode 210, and thus the maximum height of the projections 250 should be lower than the thickness of the lower electrode 210.

Meanwhile, the electric double layer capacitor of the present invention further comprises a current collector 260 between the lower electrode 210 and the lower case 200. When the current collector 260 is included, the projections 250 are embedded in the current collector 260 and connected thereto. The current collector 260 is made of a material that can effectively transfer electric charges collected in the lower electrode 210 to an external terminal. In the case of the present invention, the current collector 260 may be made of tungsten, for example, but the material for the formation of the current collector 260 is not limited thereto, and well-known materials can be used.

FIG. 6 is a cross-sectional view showing an electric double layer capacitor in accordance with another embodiment of the present invention.

In the embodiment shown in FIG. 6, one or more sealing plate lower surface projections 280 are formed on a lower surface of the sealing plate 240. The sealing plate lower surface projections 280 formed on the sealing plate 240 have the same structure as the projections 250 formed on the lower case 200. Due to the presence of the sealing plate lower surface projection 280, the upper electrode 230 and the sealing plate 240 can be strongly coupled to each other. As a result, it is possible to prevent the movement of the upper electrode 230, and thus it is possible to prevent a reduction in capacitance and the occurrence of a short circuit with the lower electrode 210 due to the movement of the electrode. Moreover, since the upper electrode 230 and the sealing plate 240 are strongly coupled together by means of the projections 280, the contact area and the bonding strength increase to reduce the contact resistance of the electric double layer capacitor, and thus the equivalent series resistance (ESR) can be reduced.

Meanwhile, another embodiment of the present invention further comprises an upper current collector 270 between the upper electrode 230 and the sealing plate 240 and, in this case, the sealing plate lower surface projections 280 are embedded in the upper current collector 270 and connected thereto.

The projections 250 and the sealing plate lower surface projections 280 of the present invention may be made of any one selected from the group consisting of nickel, zinc, copper, tungsten, aluminum, and titanium.

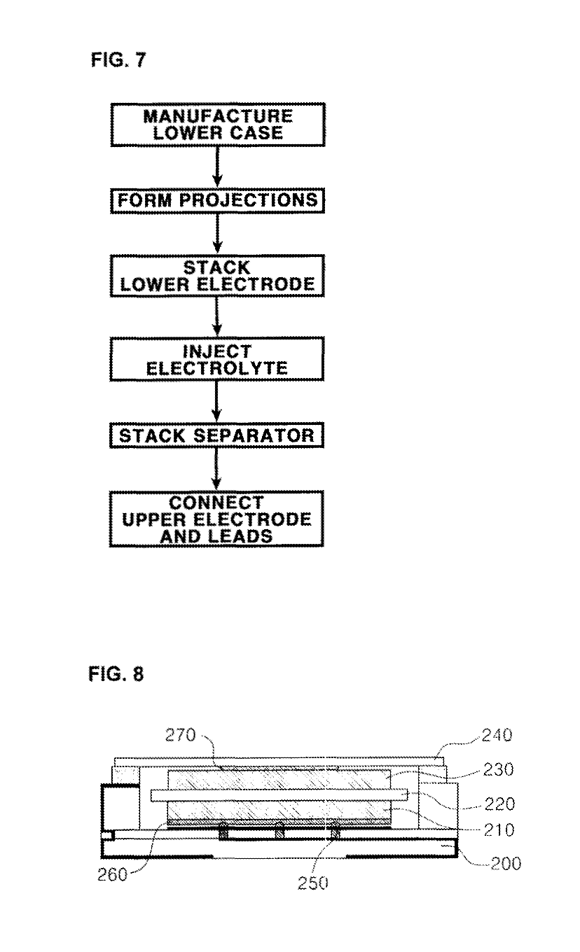

FIG. 7 is a flowchart showing a method for manufacturing an electric double layer capacitor in accordance with an embodiment of the present invention.

A method for manufacturing an electric double layer capacitor of the present invention comprises the steps of (a) forming one or more projections 250 on an inner bottom surface of a lower case 200, which is a concave container made of ceramic, (b) stacking a lower electrode 210 on the lower case 200, injecting an electrolyte, stacking a separator 220, and injecting the electrolyte again; and (c) covering the lower case 200 with a sealing plate 240 connected to an upper electrode 230.

According to the above-described method of the present invention, it is possible to eliminate the process of injecting a bonding liquid to connect the lower electrode 210 onto the lower case 200. As mentioned above, the conventional process of injecting the bonding liquid causes various problems such as the occurrence of defects during the manufacturing process, the increase of the processing time, the occurrence of damages to the device used in the process, etc. However, the present invention can eliminate the injection process, and thus it is possible to resolve the above-described problems at a single stroke.

Meanwhile, the projections 250 may be formed on the lower case 200 by printing, for example. It is possible to form the projections 250 in various ways according to desired height, size, and number of the projections 250 by injecting a projection-forming material in positions where the projections 250 are to be formed by printing. In the present invention, the meaning of the printing includes offset printing, flexo printing, silk screen printing, gravure printing, thermo-transfer printing, etc.

FIG. 8 is a cross-sectional view showing a lower case 200 of an electric double layer capacitor in accordance with an embodiment of the present invention. A plurality of sheets are stacked to form a lower surface of the lower case 200, the uppermost sheet of the plurality of stacked sheets is pierced by a via hole, a projection-forming material is injected into the via hole over the volume of the via hole to fill the via hole, and then the remaining projection-forming material is hardened on the top surface of the vial hole, thus forming the projection 250. Thus, it is possible to adjust the size and height of the projection 250 according to the amount of projection-forming material injected and, when the number of via holes is adjusted, it is possible to adjust the number of projections 250.

Meanwhile, according to another embodiment of forming the projections 250 on the lower case 200, a sheet made of carbon is stacked on the bottom surface of the lower case 200, the sheet is pierced by a via hole, and then the projection-forming material is injected into the via hole. Then, heat is applied to the lower case 200 including the sheet such that the sheet is burned and removed, thus forming the projection 250.

Before covering the lower case 200 with the sealing plate 240 connected to the upper electrode 230, the method of the present invention may further comprise the step of forming one or more sealing plate lower surface projections 280 on the lower surface of the sealing plate 240 during the process of connecting the upper electrode 230 and the sealing plate 240. This process may be performed only before the process of connecting the sealing plate 240 and the lower case 200 regardless of the order of steps (a) and (b). The sealing plate lower surface projections 280 may be formed by pressing areas other than the areas where the sealing plate lower surface projections 280 are to be formed on the sealing plate 240 such that the areas that are not pressed project.

The upper current collector 270 is stacked on the upper electrode 230 such that electric charges collected in the upper electrode 230 can be effectively transferred to an external terminal and, in this case, some or all of the sealing plate lower surface projections 280 formed on the lower surface of the sealing plate 240 are embedded in the upper current collector 270 and connected thereto.

As described above, the present invention has the following effects.

It is possible to solve various problems due to the manufacturing tolerances occurring in the production of the lower cases using ceramic. Moreover, since the lower electrode and the upper electrode are strongly coupled to the lower case and the sealing plate, respectively, by means of the projections, it is possible to prevent the lower electrode and the upper electrode from being shorted and reduce the contact resistance of the electric double layer capacitor, thus reducing the equivalent series resistance.

Moreover, it is possible to eliminate the conventional process of injecting the bonding liquid, and thus it is possible to solve the problems encountered during the process of injecting the bonding liquid, eliminate inefficiencies in the process, and simplify the manufacturing process, thus reducing the manufacturing cost.

While the invention has been shown and described with reference to certain preferred embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. An electric double layer capacitor comprising:
a lower case which is a concave container made of ceramic;
an upper electrode and a lower electrode which are arranged opposite to each other in the lower case;
a separator which is interposed between the upper electrode and the lower electrode; and
a sealing plate which covers the lower case,
wherein one or more projections are formed on an inner bottom surface of the lower case.

2. The electric double layer capacitor of claim 1, further comprising a current collector between the lower electrode and the lower case, wherein the projections are embedded in the current collector and connected thereto.

3. The electric double layer capacitor of claim 2, wherein the height of the projections is lower than the thickness of the lower electrode.

4. The electric double layer capacitor of claim 1, wherein one or more sealing plate lower surface projections are formed on a lower surface of the sealing plate.

5. The electric double layer capacitor of claim 4, further comprising an upper current collector between the upper electrode and the sealing plate, wherein the sealing plate lower surface projections are embedded in the upper current collector and connected thereto.

6. The electric double layer capacitor of claim 1, wherein the projections are made of any one selected from the group consisting of nickel, zinc, copper, tungsten, aluminum, and titanium.

7. A method for manufacturing an electric double layer capacitor, the method comprising the steps of:
(a) forming one or more projections on an inner bottom ace of a lower case, which is a concave container made of ceramic;
(b) stacking a lower electrode on the lower case, injecting an electrolyte, stacking a separator, and injecting the electrolyte again; and
(c) covering the lower case will a sealing plate connected to an upper electrode.

8. The method of claim 7, further comprising, before step (b), the step of stacking a current collector between the lower electrode and the lower case, wherein during the stacking of the current collector, the projections are embedded in the current collector and connected thereto.

9. The method of claim 7, wherein in step (a), the projections are formed on the lower case by printing.

10. The method of claim 7, wherein in step (a), the projections are formed by stacking a plurality of sheets to form a lower surface of the lower case, piercing the uppermost sheet of the plurality of stacked sheets by a via hole, and injecting a projection-forming material into the via hole over the volume of the via hole.

11. The method of claim 7, wherein step (a) comprises the steps of:
(a-1) stacking a sheet made of carbon on a bottom surface of the lower case;
(a-2) piercing the sheet by a via hole and injecting a projection-forming material into the via hole; and
(a-3) applying heat to the lower case including the sheet such that the sheet is burned and removed.

12. The method of claim 7, further comprising, before step (c), the step of forming one or more sealing plate lower surface projections on a lower surface of the sealing plate.

13. The method of claim 11, further comprising, after step (b), the step of stacking an upper current collector on the upper electrode, wherein in step (c), the sealing plate is covered such that the sealing plate lower surface projections, which are formed on the lower surface of the se g plate, are embedded in the upper current collector and connected thereto.
